(19) United States
(12) Patent Application Publication
(10) Pub. No.: US 2023/0143575 A1
(43) Pub. Date: May 11, 2023

(54) ENHANCEMENTS TO WI-FI DEVICES FOR ENABLING CYCLIC TIME-SENSITIVE APPLICATIONS WITH VERY SHORT CYCLE TIMES

(71) Applicant: Intel Corporation, Santa Clara, CA (US)

(72) Inventors: Dave Cavalcanti, Portland, OR (US); Juan Fang, Portland, OR (US); Ofer Hareuveni, Haifa (IL); Elad Oren, Tel Aviv (IL); David Shenhav, Zichron Yaaqov (IL)

(73) Assignee: Intel Corporation, Santa Clara, CA (US)

(21) Appl. No.: 17/711,688

(22) Filed: Apr. 1, 2022

Related U.S. Application Data
(60) Provisional application No. 63/283,838, filed on Nov. 29, 2021.

(51) Int. Cl. H04W 72/12; H04W 28/06

(52) U.S. Cl. CPC H04W 72/1205; H04W 28/065; H04W 84/12

(57) ABSTRACT

This disclosure describes systems, methods, and devices related to TSN operations. An access point (AP) device may generate a first time-sensitive frame; transmit the first time-sensitive frame to a station device during a transmission opportunity (TXOP) for time-sensitive operations for a station device generate a portion of a Wi-Fi management or action frame; transmit the portion of the Wi-Fi management or action frame to the station device during the transmission opportunity after transmitting the first time-sensitive frame; generate a second time-sensitive frame; and transmit the second time-sensitive frame during the transmission opportunity, wherein the first time-sensitive frame and the second time-sensitive frame are sent based on a periodicity associated with the time-sensitive operation.

### CROSS REFERENCE TO RELATED PATENT APPLICATIONS)

This application claims the benefit of U.S. Provisional Application No. 63/283,838, filed Nov. 29, 2021, the disclosure of which is incorporated by reference as set forth in full.

### TECHNICAL FIELD

This disclosure generally relates to systems and methods for wireless communications and, more particularly, to enhancements to Wi-Fi devices for enabling cyclic time-sensitive applications with very short cycle times.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for time-sensitive networking (TSN), in accordance with one or more example embodiments of the present disclosure.

FIG. 2A depicts illustrative schematic diagrams for a TSN transmissions, in accordance with one or more example embodiments of the present disclosure.

FIG. 2B depicts illustrative schematic diagrams for a TSN transmissions, in accordance with one or more example embodiments of the present disclosure.

FIG. 2C depicts illustrative schematic diagrams for a TSN transmissions, in accordance with one or more example embodiments of the present disclosure.

FIG. 2D depicts illustrative schematic diagrams for a TSN transmissions, in accordance with one or more example embodiments of the present disclosure.

FIG. 3 illustrates a flow diagram of a process for TSN operations, in accordance with one or more example embodiments of the present disclosure.

FIG. 4 illustrates a functional diagram of an exemplary communication station that may be suitable for use as a user device, in accordance with one or more example embodiments of the present disclosure.

FIG. 5 illustrates a block diagram of an example machine upon which any of one or more techniques (e.g., methods) may be performed, in accordance with one or more example embodiments of the present disclosure.

FIG. 6 is a block diagram of a radio architecture in accordance with some examples.

FIG. 7 illustrates an example front-end module circuitry for use in the radio architecture of FIG. 6, in accordance with one or more example embodiments of the present disclosure.

FIG. 8 illustrates an example radio IC circuitry for use in the radio architecture of FIG. 6, in accordance with one or more example embodiments of the present disclosure.

FIG. 9 illustrates an example baseband processing circuitry for use in the radio architecture of FIG. 6, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Emerging time-sensitive (TS) applications represent new markets for Wi-Fi. Many time-sensitive applications involve isochronous (cyclic) transmission of small packets (e.g. a few bytes) within very short cycles with high reliability. Remote I/O, motion control and HMIs (Human-Machine Interface) safety devices are example applications. A typical requirement for these applications is the cyclic transmission of data (e.g. sensor data, commands, and heartbeats) within a 1 msec cycle (or few hundreds of microseconds) with extremely high reliability. Furthermore, there are some TS applications that are event-driven (e.g. emergency/safety stop) that also require strict low latency deadlines and may operate in combination with cyclic applications. For instance, an emergency stop command may be created if a given number of heartbeat messages are not received. Thus, it is important to enable reliable cyclic transmissions continuously. When these applications are used in safety critical devices, the expected error probability must be smaller than 10⁻⁹/h as defined in the IEC 61508 Functional Safety standard for programable systems.

Although it is possible to achieve very low latency for small data frames is a Wi-Fi network (e.g. a few hundreds of microseconds, depending on BW and MCS), there are other frames (e.g. control and management frames) that are also essential for maintaining the Wi-Fi connectivity between STA and APs which need to be transmitted, such as beacons and action frames (for timing measurement and fine timing measurement). Such transmissions may cause a delay in a cyclic transmission that has a very short cycle time, such as 1 msec, as shown in the figure below. It is also important that TS and other non-TS applications are able to share the same network with high efficiency.

IEEE 802.1 TSN features such as 802.1Qbv traffic shaping can be used to create protected windows for time-critical data and prevent congestion from other types (non-TS) of traffic in the same network. However, 802.1Qbv is usually applied on the application traffic mapped to network or MAC layer queues and it may not be able to control (or shape) the transmission of 802.11 MAC frames used for control and management of the network, such as beacons. Furthermore, typical configurations of Wi-Fi features, e.g. beacon transmission and reception may take more time than the required cycle for low latency application. Additional enhancements are necessary to cyclic transmissions with very short cycles are not impacted by management/control and other supporting tasks done by the 802.11 MAC.

In addition, some TSN features, including 802.1Qbv, depend on time synchronization, which is enabled by the 802.1AS protocol. 802.1AS time synchronization is supported over 802.11/Wi-Fi links by the exchange of Timing Measurement (TM) or Fine Timing Measurement (FTM) action frames. These action frames are exchanged periodically to maintain synchronization and they may also overlap with cyclic TS application data, which may result in increased latency for the TS frames.

802.1Qbv gate control can be used to prioritize data flows mapped to 802.11 queues.

It may not be feasible to guarantee a worst-case latency and meet a short cycle time if an essential 802.11 frame (e.g. beacon, time sync action frames) mapped to a lower priority queue takes more airtime than the cycle duration.

There is therefore a need for enhancements to Wi-Fi devices to enable cyclic time sensitive applications with short cycle times while still allowing for transmission of other Wi-Fi frames.

Example embodiments of the present disclosure relate to systems, methods, and devices for enhancements to Wi-Fi devices for enabling cyclic time-sensitive applications with very short cycle times.

In one or more embodiments, a TSN system may facilitate several enhancements to Wi-Fi operations to enable time-sensitive applications with very short cycles and high reliability, including: (1) A “light” beacon and beacon-specific physical layer (PHY) configuration to constrain the used airtime and avoid interference with a cyclic time-sensitive data transmission. (2) Implementation of an adaptive beacon transmission rule to use a regular beacon when no time-sensitive networking (TSN) flows are enabled, and to use a light-beacon/low-priority mode when TSN flows are enabled. (3) Implementation of an optimized beacon interval when TSN flows are enabled. (4) Implementation of a fragmented beacon transmission mode in which a beacon frame may be partitioned into smaller medium access control (MAC) level frames, MAC protocol data units (MPDUs), reducing the transmission duration in each granted transmit opportunity (TXOP) and preventing overlapping with cyclic TS frame transmissions. (5) A low priority/delayed light beacon or action/management frame transmission when a beacon/action/management frame transmission may overlap with an expected time-sensitive data transmission. (6) Selective probe responses where the AP may decide to only respond to devices that are expected (or authorized) to be part of the network. (7) A dynamic TXOP limit configuration to ensure non-time-sensitive transmissions do not exceed the duration of the guard band used to protect the time-sensitive data.

The proposed enhancements will enable a more efficient configuration and management of network resources with better performance (e.g., lower latency) and higher reliability (e.g., less errors due to changes in wireless devices/links). The proposed enhancements will enable Wi-Fi-based wireless time sensitive networking (WTSN) products to meet the requirements of safety critical industrial applications, such as safety human machine interface (HMI) devices and industrial PCs/controllers.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

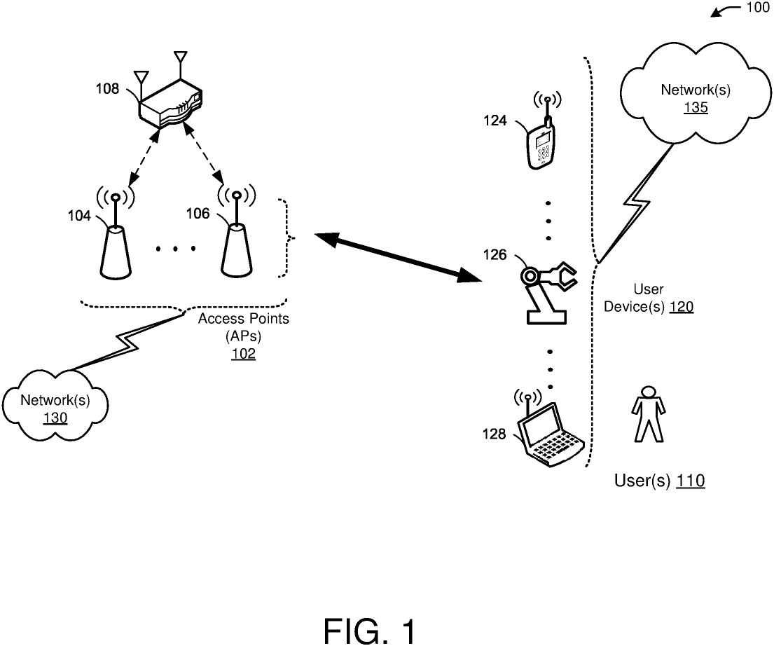

FIG. 1 is a network diagram illustrating an example network environment of my_19@, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

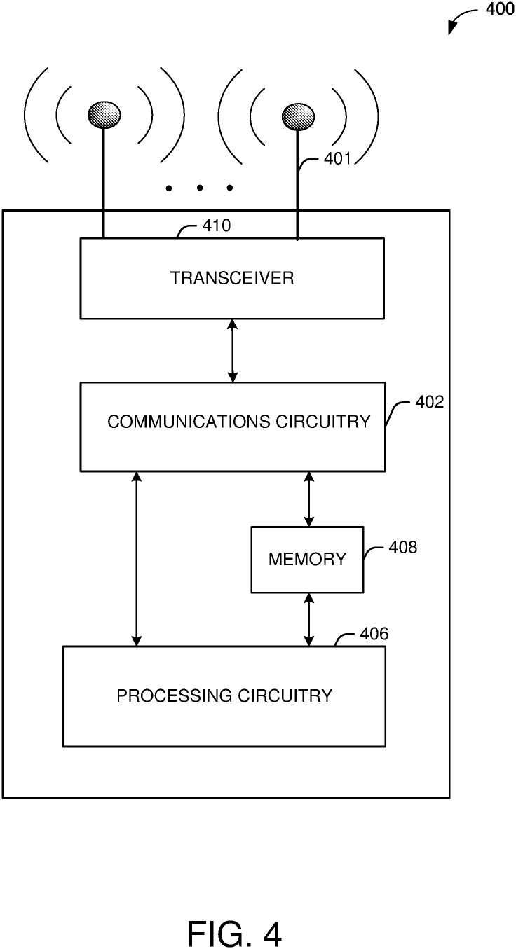

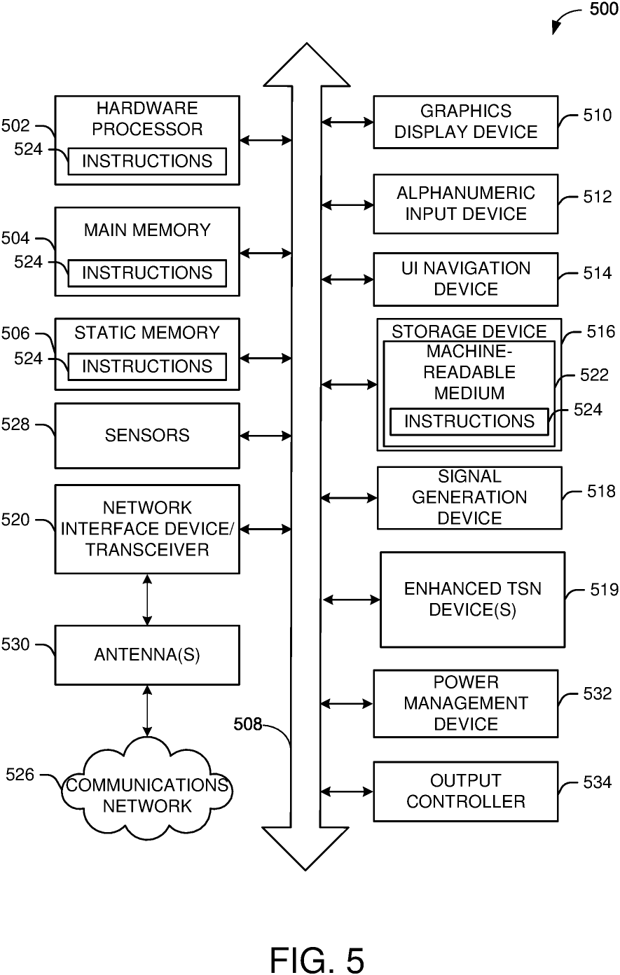

In some embodiments, the user devices 120 and the AP 102 may include one or more computer systems similar to that of the functional diagram of FIG. 4 and/or the example machine/system of FIG. 5.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabookTM computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

In one or more embodiments, a controller 108 (e.g., a wireless TSN controller) may facilitate enhanced coordination among multiple APs (e.g., AP 104 and AP 106). The controller 108 may be a central entity or another AP, and may be responsible for configuring and scheduling time sensitive control and data operations across the APs. A wireless TSN (WTSN) management protocol may be used to facilitate enhanced coordination between the APs, which may be referred to as WTSN management clients in such context. The controller 108 may enable device admission control (e.g., control over admitting devices to a WTSN), joint scheduling, network measurements, and other operations. APs may be configured to follow the WTSN protocol.

In one or more embodiments, the use of controller 108 may facilitate AP synchronization and alignment for control and data transmissions to ensure latency with high reliability for time sensitive applications on a shared time sensitive data channel, while enabling coexistence with non-time sensitive traffic in the same network.

In one or more embodiments, the controller 108 and its coordination may be adopted in future Wi-Fi standards for new bands (e.g., 6-7 GHz), in which additional requirements of time synchronization and scheduled operations may be used. Such application of the controller 1 108 may be used in managed Wi-Fi deployments (e.g., enterprise, industrial, managed home networks, etc.) in which time sensitive traffic may be steered to a dedicated channel in existing bands as well as new bands.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), 6 GHz channels and Wi-Fi channels defined in 802.11ax (e.g., Wi-Fi 6E), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

In one or more embodiments, to allow for cyclic TSN transmissions between the APs 102 and the user devices 110 while also allowing for other Wi-Fi transmissions (e.g., beacons, FTM frames, other control and action frames, etc.) as described further herein.

It is understood that the above descriptions are for purposes of illustration and are not meant to be limiting.

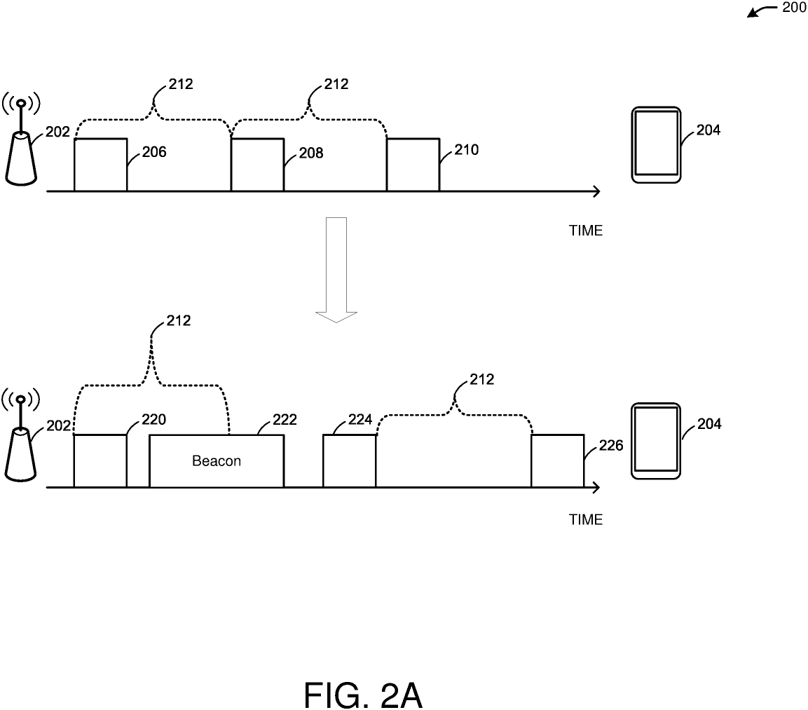

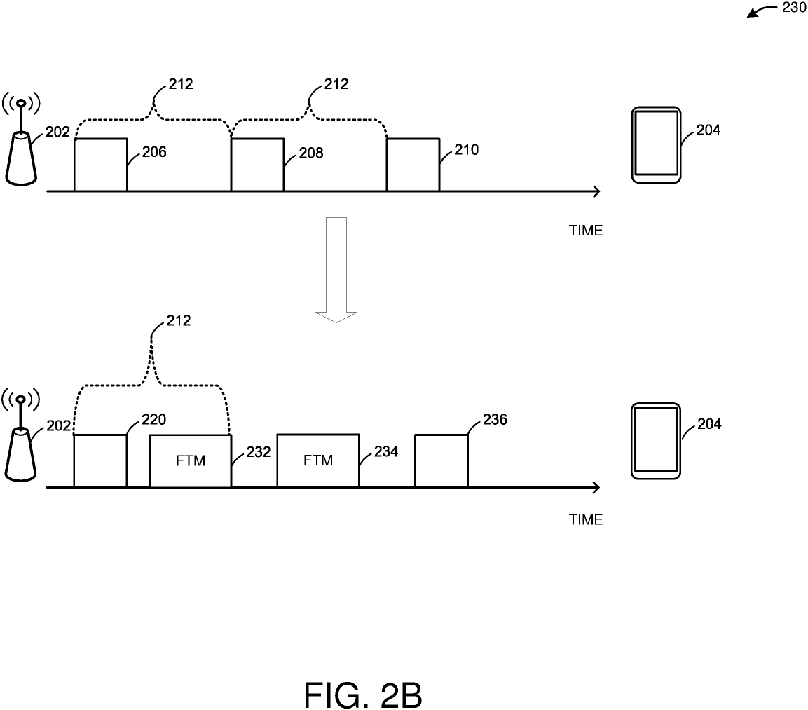

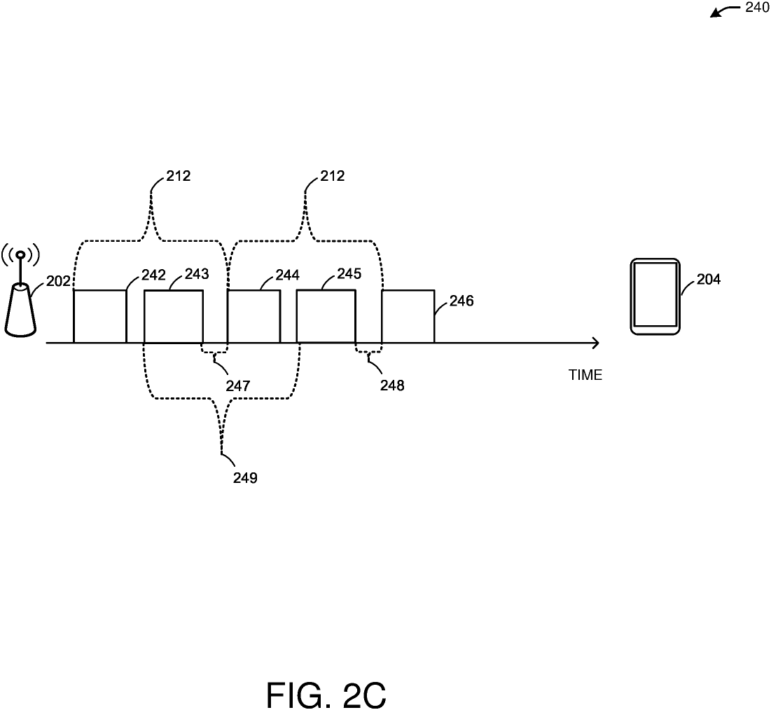

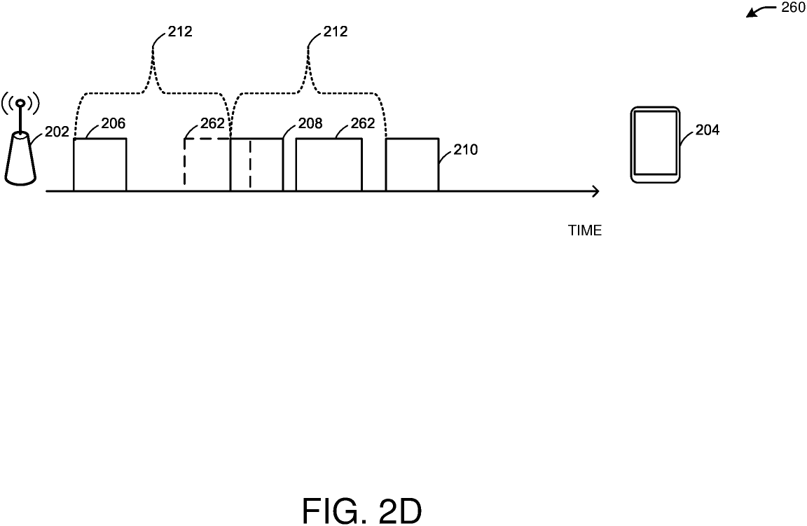

FIG. 2A depicts illustrative schematic diagrams 200 for a TSN transmissions, in accordance with one or more example embodiments of the present disclosure.

Referring to FIG. 2A, an AP 202 may send frames to a STA 204, including TS frames for TS operations, and Wi-Fi management/action frames. As shown, the AP 202 may send TS frame 206, TS frame 208, and TS 210, which may be periodic with a cycle 212. However, to send a Wi-Fi management frame such as a beacon may interrupt the cycle 212. For example, when the AP 202 sends a TS frame 220 followed by a beacon 222, the cycle 212 between the TS frame 220 and a next TS frame 224 may be interrupted (the cycle 212 shown between the TS frame 224 and a subsequent TS frame 226).

FIG. 2B depicts illustrative schematic diagrams 230 for a TSN transmissions, in accordance with one or more example embodiments of the present disclosure.

Referring to FIG. 2B, when the AP 202 sends fine timing measurement (FTM) frames as the Wi-Fi management/action frames, the FTM frames may interrupt the cycle 212 similar to the beacon 222 in FIG. 2A. The AP 202 may send the TS frame 220 followed by a FTM frame 232, followed by a FTM frame 234, followed by the TS frame 236, resulting in the TS frame 236 not being sent within the required cycle 212 for TSN operations.

FIG. 2C depicts illustrative schematic diagrams 240 for a TSN transmissions, in accordance with one or more example embodiments of the present disclosure.

Referring to FIG. 2C, the AP 202 may send a TS frame 242, followed by a Wi-Fi management/action frame 243, followed by a TS frame 244, followed by a Wi-Fi management/action frame 245, followed by a TS frame 246. In FIG. 2C, the cycle 212 is maintained between consecutive TS frames.

In one or more embodiments, the Wi-Fi management/action frame 243 and the Wi-Fi management/action frame 245 may represent a light beacon, which may be a portion of a normal Wi-Fi beacon. When the AP 202 detects that TSN operations are being used, the AP 202 may generate and send the Wi-Fi management/action frame 243 and the Wi-Fi management/action frame 245 as a light beacon or other type of “light” Wi-Fi action/management frame (e.g., a Wi-Fi action or management frame shorter than currently defined by the 802.11 standards, such as 802.11ax or the 2016 802.11 standard). When no TSN operations are detected, the Wi-Fi management/action frame 243 and the Wi-Fi management/action frame 245 may be normal beacons.

In one or more embodiments, the time period shown in FIG. 2C may represent a TXOP for the STA 204. The AP 202 may adjust the TXOP dynamically. For example, after transmission of the Wi-Fi management/action frame 243 and the Wi-Fi management/action frame 245, the AP 202 may wait for a guard interval 247 or 248 before another transmission. Prioritization alone is insufficient to address the needs of applications that require high predictability in term of the time at which the frame transmission shall occur. If a low priority frame is already being transmitted, then the transmission will complete before a higher priority frame can access the medium. Therefore, it is necessary to stop the transmission of unprotected (low priority) sufficiently far in advance of the high priority frame transmission to ensure the last low priority transmission has completed before the high priority transmission starts. The gap that is left between the end of the low priority transmission and the start of the high priority transmission is called guard band. In the guard band, transmission of new low priority frames is not permitted between the start of the guard band and the start of the high priority time window. This guard band in the worst case is as long as the maximum sized frame transmission time. However, the start of the guard band need not be fixed if the implementation supports TXOP limiting. In this method, in each start of the low priority transmission, the implementation calculates the time that is left until the start of the high priority frame transmission, and limits the TXOP (by controlling the number of MPDUs it adds to the aggregation) to such a value that, including the acknowledgement, will not exceed the starting time of the high priority frame transmission, minus some small protection. In this method, the guard band is minimal, but the implementation should stop transmission of the low priority frames even if it doesn’t get acknowledgment, postponing any retransmissions to after the high priority time windows ends. If there is not enough time even for one low priority frame, the implementation shall not start the low priority frame transmission. Supporting dynamic TXOP limiting can optimize the network efficiency and assure that low priority traffic will not interfere with high priority traffic. If the device sending low priority data is the same device that has high priority (TS) transmissions, it may use its own local information about the scheduled TS transmissions to decide how to adapt the TXOP limits for low priority traffic. If the device has only low priority traffic, it may use information provided by the AP about scheduled protected periods for TS traffic to decide on when and how to adapt its TXOP limits.

In one or more embodiments, when the Wi-Fi management/action frame 243 and the Wi-Fi management/action frame 245 are beacons or light beacons, the beacon interval between respective beacons (e.g., beacon interval 249) may be set by the AP 202 to be an optimized time interval when the AP 202 detects TSN operations.

In one or more embodiments, when the Wi-Fi management/action frame 243 and the Wi-Fi management/action frame 245 are beacons, the transmission of the beacons may be fragmented, meaning that the beacons may be partitioned into smaller portions (e.g., MPDUs). Fragmentation/defragmentation was defined in 802.11 (Section 10.2.6), which is to partition an MSDU or an MMPDU into smaller MAC level frames, MPDUs, for transmission, and then recombine the received MPDUs back to a single MSDU or MMPDU at the receiver side. This feature enables the STA to use the medium efficiently in consideration of the duration available in granted TXOPs. To avoid the effect to the TS frame transition, the TXOP should be kept within certain limitation. Therefore, if the beacon frame is too large to be transmitted in a granted small TXOP, fragmentation/defragmentation of the beacon frame is a good way to solve the problem.

In one or more embodiments the Wi-Fi management/action frame 243 and the Wi-Fi management/action frame 245 may represent probe responses. The AP 202 may determine whether the STA 204 is authorized to join a network of the AP 202 prior to sending the probe responses, and may avoid sending a probe response when the STA 204 is not authorized to join a network of the AP 202. A major concern in the deployment of TS networks is the media occupancy resulted from devices searching for Wi-Fi networks. Any Wi-Fi device such as mobile phone, PC, table or IOT device (e.g. Webcam), is periodically scanning all its supported channels for detection of access points. General purpose access points are expected to respond to any probe request by a probe response that provides the complete information on the AP capabilities to allow the scanning device to decide if it should try to associate to this network. Typically, these probe requests are not including a specific network identifier (SSID), as their goal is to get response from all APs on channel in vicinity. However, as a TS network is not expected to allow association to any station, it may choose to respond only to stations that specify its network identifier (SSID) in its probe requests (aka directed probe request). In one embodiment, the AP may verify the identity of a STA sending a probe request and only respond if the device is identified as a TS device that is allowed to join the network. In another embodiment, the AP may be configured to only allow association and response to probe requests during certain times and/or using certain channels (e.g. at initial configuration when TS flows are not active) and not respond to any probe request outside of such times. For example, the AP 202 may send a probe response, in response to receiving a probe request from the STA 204, using a separate link (e.g., separate from the link used for TSN communications). The separate link may be dedicated only for device association.

In one or more embodiments, the STA 204 may refrain from sending a probe request to the AP 202 when the STA 204 is preconfigured to operate as a TSN-capable device and is aware of an active TSN application. When there is a dedcated channel used for the AP 202 to enable association, the STA 204 may send a probe request using the dedicated channel (e.g., when the TSN data is transmitted using a different channel). In this manner, the STA 204 may avoid sending a probe request in a channel used for TSN transmissions.

In one or more embodiments, it is acceptable to assume that a private network that is designed to support TS applications should not support the features/capabilities to serve Wi-Fi devices that are not intended to be used on such network from discovering, authenticating and associating to such network. In addition, it can be assumed that enabling of device features like power save mechanisms, beam forming, overlapping basic service set (OBSS) coexistence optimizations, and a sub-set of protocol security suites, is not required on such private network. Under such considerations, beacons and traffic indication map (TIM) elements may be reduced to minimum size and transmitted in high rates. While the duration of a typical beacon on a general purpose network may be in the range of 150 to 200 usecs, the Wi-Fi management/action frame 243 and the Wi-Fi management/action frame 245 as light beacons may be reduced to 30 to 40 microseconds (usecs or µs), while still complying with IEEE 802.11 protocol. With such short beacons, the probability of interference with TS data transmissions can be significantly reduced, more time can be used to support TS data transmissions.

FIG. 2D depicts illustrative schematic diagrams 260 for a TSN transmissions, in accordance with one or more example embodiments of the present disclosure.

Referring to FIG. 2D, when the AP 202 detects that transmitting a Wi-Fi management/action frame 262 would overlap with a transmission of the TS frame 208 (e.g., would interrupt the cycle 212), the AP 202 may delay the transmission of the Wi-Fi management/action frame 262 to a later time (e.g., after the transmission of the TS frame 208). Like in FIGS. 2A-2C, the time period shown in FIG. 2D may represent a TXOP for the STA 204.

In one or more embodiments, the regular or light action/management frame transmissions may also be delayed when they are expected to overlap with an upcoming TS data transmission. The same principle can be applied to other action/management frames, such as TM/FTM frames used for periodic time synchronization, which is a key TSN feature. Although such frames are important to maintain the TSN operation, their specific transmission times may be delayed when an upcoming TS data is expected without significant impact on the time synchronization accuracy. The decision to delay a TM/FTM frame may be taken by the originator of the session (e.g. leader), which may be the AP 202 or the STA 204. In another embodiment, the beacon interval may also be updated when the TS data flows are active to avoid overlaps. The typical beacon periodicity of 100 msec maybe changed or an offset added to avoid a potential overlap with TS data (e.g., the beacon interval may be set as shown in FIG. 2C to avoid the overlap).

Referring to FIGS. 2C and 2D, the transmissions of the AP 202 may be made by the STA 204 or by another STA (e.g., one of the user devices 120 of FIG. 1). In this manner, the STA 204 may avoid transmitting at times that interrupt the cycle 212 for TSN transmissions.

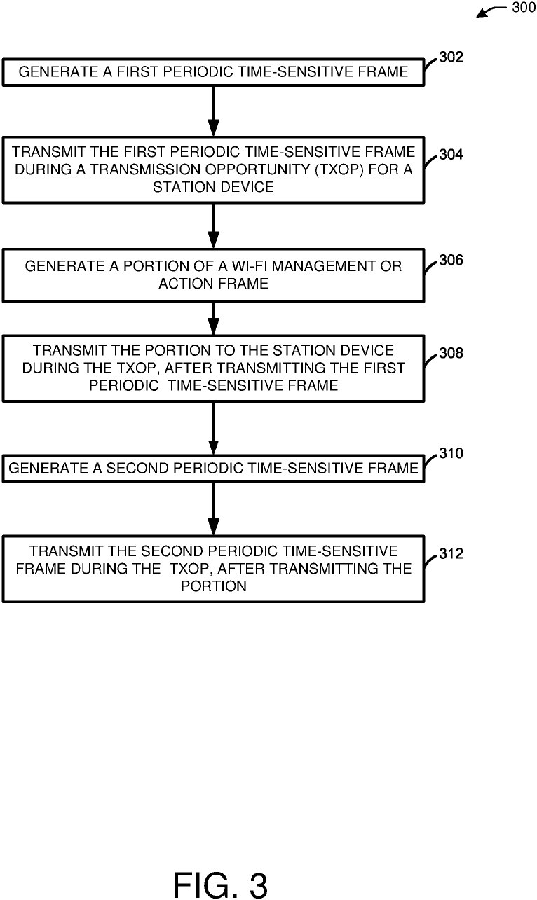

FIG. 3 illustrates a flow diagram of a process 300 for TSN operations, in accordance with one or more example embodiments of the present disclosure.

At block 302, a device (e.g., the AP 1XX02 of FIG. 1 and/or the enhanced TSN device 519 of FIG. 5) may generate a first periodic/cyclic TS frame (e.g., the TS frame 242 of FIG. 2C, the TS frame 206 of FIG. 2D). The first TS frame may be sent during a TXOP for a station device (e.g., one of the user devices 120 of FIG. 1, the STA 204 of FIG. 2C and FIG. 2D), and the TXOP may be scheduled to allow for low-latency TS operations.

At block 304, the device may transmit the first periodic TS frame during the TXOP for the station device.

At block 306, the device may generate a portion of a Wi-Fi management or action frame (e.g., the Wi-Fi management/action frame 243 of FIG. 2C, the Wi-Fi management or action frame 262 of FIG. 2D), which may represent a light becon (e.g., shorter than a normal Wi-Fi beacon) or other light Wi-Fi management/action frame, a fragmented beacon (e.g., including MPDUs), a probe response (e.g., based on a determination that the STA is authorized to associate to the device), or another action/management frame. The device may set a beacon interval when the Wi-Fi management or action frame is a beacon, the beacon interval representing the time between two consecutive beacons to be sent by the device. The beacon interval may be set to avoid overlap with any periodic/cyclic TS frame transmission during the TXOP.

At block 308, the device may transmit the portion of the Wi-Fi management or action frame during the TXOP after transmission of the first TS frame. The portion of the Wi-Fi management or action frame may be transmitted at a time that does not overlap or interrupt the cycle of TS frames. For example, the device may condition the transmission of the Wi-Fi management or action frame on whether the transmission plus a guard interval after the transmission will complete prior to a scheduled cyclic second TS frame during the TXOP. The portion may be transmitted as a light beacon (or other light Wi-Fi management/action frame) or as a MPDU of a fragmented beacon that may include multiple MDPUs. The portion may be transmitted within a probe response.

At block 310, the device may generate a second periodic TS frame (e.g., the TS frame 245 of FIG. 2C).

At block 312, the device may transmit the second periodic TS frame during the TXOP, either after transmission of the portion of the Wi-Fi management or action frame, or before. The first and second periodic TS frames may be sent according to their cycle, so the transmission of the portion of the Wi-Fi management or action frame may occur in between the cyclic TS frame transmissions, or may be delayed until after transmission of the second periodic TS frame to avoid interrupting the cycle.

It is understood that the above descriptions are for purposes of illustration and are not meant to be limiting.

FIG. 4 shows a functional diagram of an exemplary communication station 400, in accordance with one or more example embodiments of the present disclosure. In one embodiment, FIG. 4 illustrates a functional block diagram of a communication station that may be suitable for use as an AP 102 (FIG. 1) or a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), an enhanced TSN device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 502 for generation and processing of the baseband signals and for controlling operations of the main memory 504, the storage device 516, and/or the enhanced TSN device 519. The baseband processor may be provided on a single radio card, a single chip, or an integrated circuit (IC).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The enhanced TSN device 519 may carry out or perform any of the operations and processes (e.g., process 300) described and shown above.

It is understood that the above are only a subset of what the enhanced TSN device 519 may be configured to perform and that other functions included throughout this disclosure may also be performed by the enhanced TSN device 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD- ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-FiⓇ, IEEE 802.16 family of standards known as WiMaxⓇ), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

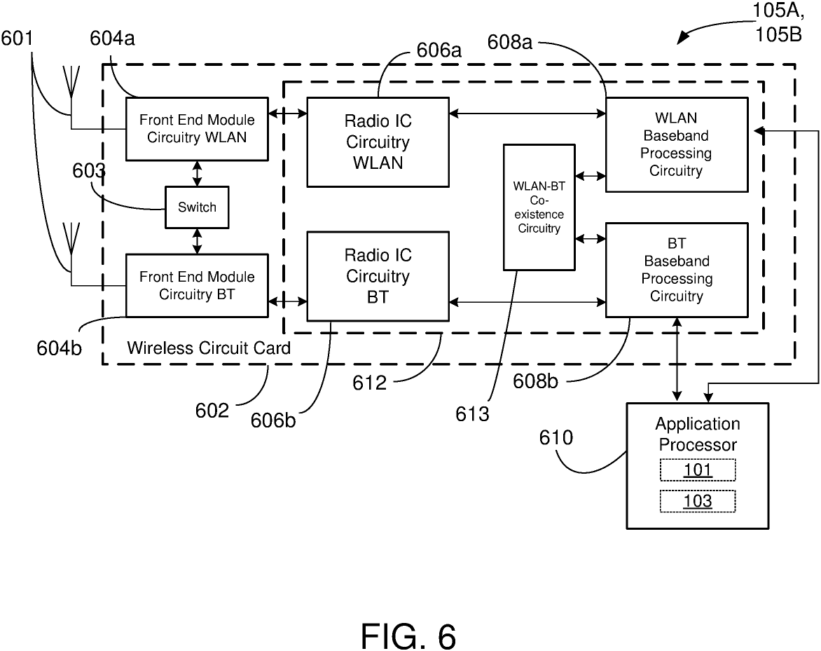

FIG. 6 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 604a-b, radio IC circuitry 606a-b and baseband processing circuitry 608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 604a-b may include a WLAN or Wi-Fi FEM circuitry 604a and a Bluetooth (BT) FEM circuitry 604b. The WLAN FEM circuitry 604a may include a receive signal path comprising circuitry configured to operate on WLAN RF signals received from one or more antennas 601, to amplify the received signals and to provide the amplified versions of the received signals to the WLAN radio IC circuitry 606a for further processing. The BT FEM circuitry 604b may include a receive signal path which may include circuitry configured to operate on BT RF signals received from one or more antennas 601, to amplify the received signals and to provide the amplified versions of the received signals to the BT radio IC circuitry 606b for further processing. FEM circuitry 604a may also include a transmit signal path which may include circuitry configured to amplify WLAN signals provided by the radio IC circuitry 606a for wireless transmission by one or more of the antennas 601. In addition, FEM circuitry 604b may also include a transmit signal path which may include circuitry configured to amplify BT signals provided by the radio IC circuitry 606b for wireless transmission by the one or more antennas. In the embodiment of FIG. 6, although FEM 604a and FEM 604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 606a-b as shown may include WLAN radio IC circuitry 606a and BT radio IC circuitry 606b. The WLAN radio IC circuitry 606a may include a receive signal path which may include circuitry to down-convert WLAN RF signals received from the FEM circuitry 604a and provide baseband signals to WLAN baseband processing circuitry 608a. BT radio IC circuitry 606b may in turn include a receive signal path which may include circuitry to down-convert BT RF signals received from the FEM circuitry 604b and provide baseband signals to BT baseband processing circuitry 608b. WLAN radio IC circuitry 606a may also include a transmit signal path which may include circuitry to up-convert WLAN baseband signals provided by the WLAN baseband processing circuitry 608a and provide WLAN RF output signals to the FEM circuitry 604a for subsequent wireless transmission by the one or more antennas 601. BT radio IC circuitry 606b may also include a transmit signal path which may include circuitry to up-convert BT baseband signals provided by the BT baseband processing circuitry 608b and provide BT RF output signals to the FEM circuitry 604b for subsequent wireless transmission by the one or more antennas 601. In the embodiment of FIG. 6, although radio IC circuitries 606a and 606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 608a-b may include a WLAN baseband processing circuitry 608a and a BT baseband processing circuitry 608b. The WLAN baseband processing circuitry 608a may include a memory, such as, for example, a set of RAM arrays in a Fast Fourier Transform or Inverse Fast Fourier Transform block (not shown) of the WLAN baseband processing circuitry 608a. Each of the WLAN baseband circuitry 608a and the BT baseband circuitry 608b may further include one or more processors and control logic to process the signals received from the corresponding WLAN or BT receive signal path of the radio IC circuitry 606a-b, and to also generate corresponding WLAN or BT baseband signals for the transmit signal path of the radio IC circuitry 606a-b. Each of the baseband processing circuitries 608a and 608b may further include physical layer (PHY) and medium access control layer (MAC) circuitry, and may further interface with a device for generation and processing of the baseband signals and for controlling operations of the radio IC circuitry 606a-b.

Referring still to FIG. 6, according to the shown embodiment, WLAN-BT coexistence circuitry 613 may include logic providing an interface between the WLAN baseband circuitry 608a and the BT baseband circuitry 608b to enable use cases requiring WLAN and BT coexistence. In addition, a switch 603 may be provided between the WLAN FEM circuitry 604a and the BT FEM circuitry 604b to allow switching between the WLAN and BT radios according to application needs. In addition, although the antennas 601 are depicted as being respectively connected to the WLAN FEM circuitry 604a and the BT FEM circuitry 604b, embodiments include within their scope the sharing of one or more antennas as between the WLAN and BT FEMs, or the provision of more than one antenna connected to each of FEM 604a or 604b.

In some embodiments, the front-end module circuitry 604a-b, the radio IC circuitry 606a-b, and baseband processing circuitry 608a-b may be provided on a single radio card, such as wireless radio card 602. In some other embodiments, the one or more antennas 601, the FEM circuitry 604a-b and the radio IC circuitry 606a-b may be provided on a single radio card. In some other embodiments, the radio IC circuitry 606a-b and the baseband processing circuitry 608a-b may be provided on a single chip or integrated circuit (IC), such as IC 612.

In some embodiments, the wireless radio card 602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.1 1ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80 \+80 MHz (160 MHz) (with non-contiguous bandwidths). In some embodiments, a 920 MHz channel bandwidth may be used. The scope of the embodiments is not limited with respect to the above center frequencies however.

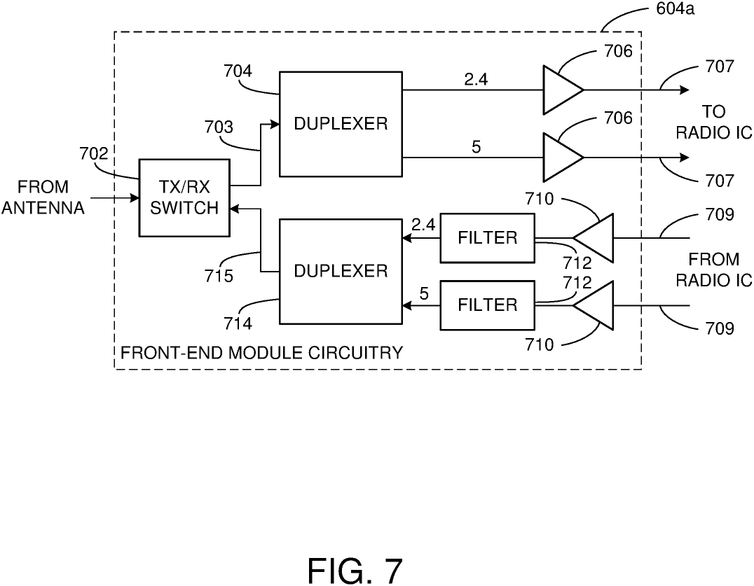

FIG. 7 illustrates WLAN FEM circuitry 604a in accordance with some embodiments. Although the example of FIG. 7 is described in conjunction with the WLAN FEM circuitry 604a, the example of FIG. 7 may be described in conjunction with the example BT FEM circuitry 604b (FIG. 6), although other circuitry configurations may also be suitable.

In some embodiments, the FEM circuitry 604a may include a TX/RX switch 702 to switch between transmit mode and receive mode operation. The FEM circuitry 604a may include a receive signal path and a transmit signal path. The receive signal path of the FEM circuitry 604a may include a low-noise amplifier (LNA) 706 to amplify received RF signals 703 and provide the amplified received RF signals 707 as an output (e.g., to the radio IC circuitry 606a-b (FIG. 6)). The transmit signal path of the circuitry 604a may include a power amplifier (PA) to amplify input RF signals 709 (e.g., provided by the radio IC circuitry 606a-b), and one or more filters 712, such as band-pass filters (BPFs), low-pass filters (LPFs) or other types of filters, to generate RF signals 715 for subsequent transmission (e.g., by one or more of the antennas 601 (FIG. 6)) via an example duplexer 714.

In some dual-mode embodiments for Wi-Fi communication, the FEM circuitry 604a may be configured to operate in either the 2.4 GHz frequency spectrum or the 5 GHz frequency spectrum. In these embodiments, the receive signal path of the FEM circuitry 604a may include a receive signal path duplexer 704 to separate the signals from each spectrum as well as provide a separate LNA 706 for each spectrum as shown. In these embodiments, the transmit signal path of the FEM circuitry 604a may also include a power amplifier 710 and a filter 712, such as a BPF, an LPF or another type of filter for each frequency spectrum and a transmit signal path duplexer 704 to provide the signals of one of the different spectrums onto a single transmit path for subsequent transmission by the one or more of the antennas 601 (FIG. 6). In some embodiments, BT communications may utilize the 2.4 GHz signal paths and may utilize the same FEM circuitry 604a as the one used for WLAN communications.

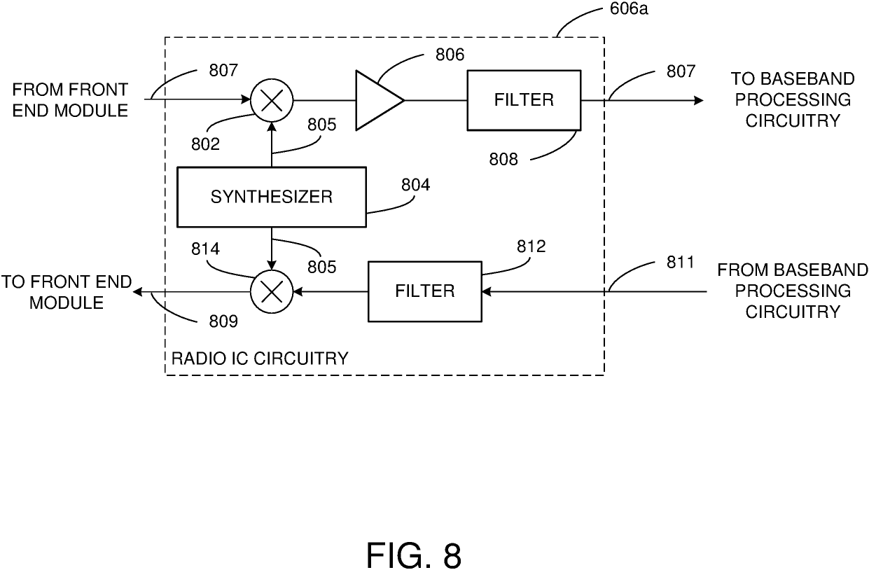

FIG. 8 illustrates radio IC circuitry 606a in accordance with some embodiments. The radio IC circuitry 606a is one example of circuitry that may be suitable for use as the WLAN or BT radio IC circuitry 606a/606b (FIG. 6), although other circuitry configurations may also be suitable. Alternatively, the example of FIG. 8 may be described in conjunction with the example BT radio IC circuitry 606b.

In some embodiments, the radio IC circuitry 606a may include a receive signal path and a transmit signal path. The receive signal path of the radio IC circuitry 606a may include at least mixer circuitry 802, such as, for example, down-conversion mixer circuitry, amplifier circuitry 806 and filter circuitry 808. The transmit signal path of the radio IC circuitry 606a may include at least filter circuitry 812 and mixer circuitry 814, such as, for example, up-conversion mixer circuitry. Radio IC circuitry 606a may also include synthesizer circuitry 804 for synthesizing a frequency 805 for use by the mixer circuitry 802 and the mixer circuitry 814. The mixer circuitry 802 and/or 814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 8 illustrates only a simplified version of a radio IC circuitry, and may include, although not shown, embodiments where each of the depicted circuitries may include more than one component. For instance, mixer circuitry 814 may each include one or more mixers, and filter circuitries 808 and/or 812 may each include one or more filters, such as one or more BPFs and/or LPFs according to application needs. For example, when mixer circuitries are of the direct-conversion type, they may each include two or more mixers.

In some embodiments, mixer circuitry 802 may be configured to down-convert RF signals 707 received from the FEM circuitry 604a-b (FIG. 6) based on the synthesized frequency 805 provided by synthesizer circuitry 804. The amplifier circuitry 806 may be configured to amplify the down-converted signals and the filter circuitry 808 may include an LPF configured to remove unwanted signals from the down-converted signals to generate output baseband signals 807. Output baseband signals 807 may be provided to the baseband processing circuitry 608a-b (FIG. 6) for further processing. In some embodiments, the output baseband signals 807 may be zero-frequency baseband signals, although this is not a requirement. In some embodiments, mixer circuitry 802 may comprise passive mixers, although the scope of the embodiments is not limited in this respect.

In some embodiments, the mixer circuitry 814 may be configured to up-convert input baseband signals 811 based on the synthesized frequency 805 provided by the synthesizer circuitry 804 to generate RF output signals 709 for the FEM circuitry 604a-b. The baseband signals 811 may be provided by the baseband processing circuitry 608a-b and may be filtered by filter circuitry 812. The filter circuitry 812 may include an LPF or a BPF, although the scope of the embodiments is not limited in this respect.

In some embodiments, the mixer circuitry 802 and the mixer circuitry 814 may each include two or more mixers and may be arranged for quadrature down-conversion and/or up-conversion respectively with the help of synthesizer 804. In some embodiments, the mixer circuitry 802 and the mixer circuitry 814 may each include two or more mixers each configured for image rejection (e.g., Hartley image rejection). In some embodiments, the mixer circuitry 802 and the mixer circuitry 814 may be arranged for direct down-conversion and/or direct up-conversion, respectively. In some embodiments, the mixer circuitry 802 and the mixer circuitry 814 may be configured for super-heterodyne operation, although this is not a requirement.

Mixer circuitry 802 may comprise, according to one embodiment: quadrature passive mixers (e.g., for the in-phase (I) and quadrature phase (Q) paths). In such an embodiment, RF input signal 707 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 805 of synthesizer 804 (FIG. 8). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 707 (FIG. 7) may comprise a balanced signal, although the scope of the embodiments is not limited in this respect. The I and Q baseband output signals may be provided to low-noise amplifier, such as amplifier circuitry 806 (FIG. 8) or to filter circuitry 808 (FIG. 8).

In some embodiments, the output baseband signals 807 and the input baseband signals 811 may be analog baseband signals, although the scope of the embodiments is not limited in this respect. In some alternate embodiments, the output baseband signals 807 and the input baseband signals 811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 804 may be a fractional-N synthesizer or a fractional N/N+1 synthesizer, although the scope of the embodiments is not limited in this respect as other types of frequency synthesizers may be suitable. For example, synthesizer circuitry 804 may be a delta-sigma synthesizer, a frequency multiplier, or a synthesizer comprising a phase-locked loop with a frequency divider. According to some embodiments, the synthesizer circuitry 804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 804 may be provided by a voltage controlled oscillator (VCO), although that is not a requirement. A divider control input may further be provided by either the baseband processing circuitry 608a-b (FIG. 6) depending on the desired output frequency 805. In some embodiments, a divider control input (e.g., N) may be determined from a look-up table (e.g., within a Wi-Fi card) based on a channel number and a channel center frequency as determined or indicated by the example application processor 610. The application processor 610 may include, or otherwise be connected to, one of the example secure signal converter 101 or the example received signal converter 103 (e.g., depending on which device the example radio architecture is implemented in).

In some embodiments, synthesizer circuitry 804 may be configured to generate a carrier frequency as the output frequency 805, while in other embodiments, the output frequency 805 may be a fraction of the carrier frequency (e.g., one-half the carrier frequency, one-third the carrier frequency). In some embodiments, the output frequency 805 may be a LO frequency (fLO).

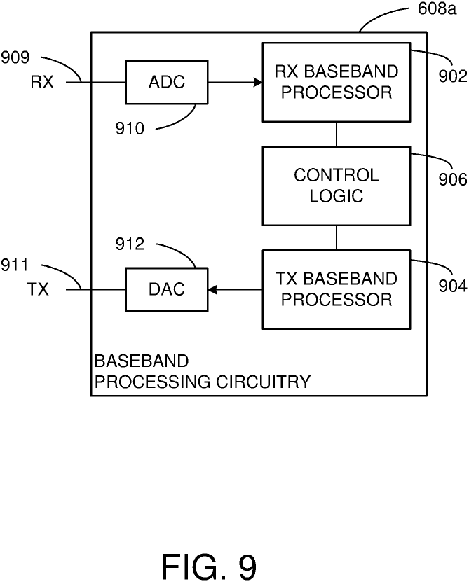

FIG. 9 illustrates a functional block diagram of baseband processing circuitry 608a in accordance with some embodiments. The baseband processing circuitry 608a is one example of circuitry that may be suitable for use as the baseband processing circuitry 608a (FIG. 6), although other circuitry configurations may also be suitable. Alternatively, the example of FIG. 8 may be used to implement the example BT baseband processing circuitry 608b of FIG. 6.

The baseband processing circuitry 608a may include a receive baseband processor (RX BBP) 902 for processing receive baseband signals 809 provided by the radio IC circuitry 606a-b (FIG. 6) and a transmit baseband processor (TX BBP) 904 for generating transmit baseband signals 811 for the radio IC circuitry 606a-b. The baseband processing circuitry 608a may also include control logic 906 for coordinating the operations of the baseband processing circuitry 608a.

In some embodiments (e.g., when analog baseband signals are exchanged between the baseband processing circuitry 608a-b and the radio IC circuitry 606a-b), the baseband processing circuitry 608a may include ADC 910 to convert analog baseband signals 909 received from the radio IC circuitry 606a-b to digital baseband signals for processing by the RX BBP 902. In these embodiments, the baseband processing circuitry 608a may also include DAC 912 to convert digital baseband signals from the TX BBP 904 to analog baseband signals 911.

In some embodiments that communicate OFDM signals or OFDMA signals, such as through baseband processor 608a, the transmit baseband processor 904 may be configured to generate OFDM or OFDMA signals as appropriate for transmission by performing an inverse fast Fourier transform (IFFT). The receive baseband processor 902 may be configured to process received OFDM signals or OFDMA signals by performing an FFT. In some embodiments, the receive baseband processor 902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 6, in some embodiments, the antennas 601 (FIG. 6) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multistandard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may be an apparatus of a Wi-Fi device, the apparatus comprising processing circuitry coupled to storage, the processing circuitry configured to: generate a first time-sensitive frame; transmit the first time-sensitive frame to a station device during a transmission opportunity (TXOP) for time-sensitive operations for a station device generate a portion of a Wi-Fi management or action frame; transmit the portion of the Wi-Fi management or action frame to the station device during the transmission opportunity after transmitting the first time-sensitive frame; generate a second time-sensitive frame; and transmit the second time-sensitive frame during the transmission opportunity, wherein the first time-sensitive frame and the second time-sensitive frame are sent based on a periodicity associated with the time-sensitive operations.

Example 2 may include the apparatus of example 1 and/or some other example herein, wherein the portion of the Wi-Fi management or action frame is a reduced size Wi-Fi management or action frame.

Example 3 may include the apparatus of example 2 and/or some other example herein, wherein a duration of the reduced size Wi-Fi management or action frame has a duration less than the a beacon defined by 802.11ax.

Example 4 may include the apparatus of example 1 and/or some other example herein, wherein to transmit the portion of the Wi-Fi management or action frame to the station device comprises to transmit medium access control (MAC) layer protocol data units (MPDUs), the MPDUs comprising the portion of the Wi-Fi management or action frame.

Example 5 may include the apparatus of example 1 and/or some other example herein, wherein the processing circuitry is further configured to identify the time-sensitive operations, and wherein the portion of the Wi-Fi management or action frame is transmitted based on the identification of the time-sensitive operations.

Example 6 may include the apparatus of example 1 and/or some other example herein, wherein the processing circuitry is further configured to set a beacon interval between transmission of a first beacon comprising the portion of the Wi-Fi management or action frame and transmission of a second beacon based on the identification of the time-sensitive operations, wherein the portion of the Wi-Fi management or action frame is a portion of the first beacon, and wherein the portion of the Wi-Fi management or action frame is transmitted in the first beacon based on the beacon interval.

Example 7 may include the apparatus of example 5 and/or some other example herein, wherein the processing circuitry is further configured to determine that a first time to transmit the portion of the Wi-Fi management or action frame overlaps the transmission of the second time-sensitive frame, and wherein the portion of the Wi-Fi management or action frame is transmitted at a second time after the first time based on the overlap.

Example 8 may include the apparatus of example 1 and/or some other example herein, wherein the portion of the Wi-Fi management or action frame is part of a probe response, wherein the processing circuitry is further configured to determine that the station device is associated to a network of the AP device, and wherein the portion of the Wi-Fi management or action frame is transmitted based on the determination that the station device is associated to the network of the AP device.

Example 9 may include the apparatus of example 1 and/or some other example herein, wherein the processing circuitry is further configured to: determine, during transmission of the portion of the Wi-Fi management or action frame, a time until the transmission of the second time-sensitive frame; and setting, based on the time until the transmission of the second time-sensitive frame, a guard band between transmission of the portion of the Wi-Fi management or action frame, wherein the second time-sensitive frame and the portion of the Wi-Fi management or action frame are transmitted based on the guard band.

Example 10 may include the apparatus of example 1 and/or some other example herein, further comprising a transceiver configured to transmit and receive wireless signals comprising the portion of the Wi-Fi management or action frame, the first time-sensitive frame, and the second time-sensitive frame.

Example 11 may include the apparatus of example 10 and/or some other example herein, further comprising one or more antennas coupled to the transceiver.

Example 12 may include a computer-readable storage medium comprising instructions to cause processing circuitry of a Wi-Fi device, upon execution of the instructions by the processing circuitry, to: generate a first time-sensitive frame; transmit the first time-sensitive frame to a station device during a transmission opportunity (TXOP) for time-sensitive operations for a station device generate a portion of a Wi-Fi management or action frame; transmit the portion of the Wi-Fi management or action frame to the station device during the transmission opportunity after transmitting the first time-sensitive frame; generate a second time-sensitive frame; and transmit the second time-sensitive frame during the transmission opportunity, wherein the first time-sensitive frame and the second time-sensitive frame are sent based on a periodicity associated with the time-sensitive operations.

Example 13 may include the computer-readable medium of example 12 and/or some other example herein, wherein the portion of the Wi-Fi management or action frame is a reduced size Wi-Fi management or action frame.

Example 14 may include the computer-readable medium of example 13 and/or some other example herein, wherein a duration of the reduced size Wi-Fi management or action frame has a duration less than the a beacon defined by 802.1 1ax.

Example 15 may include the non-transitory computer-readable medium of example 12 and/or some other example herein, wherein to transmit the portion of the Wi-Fi management or action frame to the station device comprises to transmit medium access control (MAC) layer protocol data units (MPDUs), the MPDUs comprising the portion of the Wi-Fi management or action frame.

Example 16 may include the non-transitory computer-readable medium of example 12 and/or some other example herein, wherein execution of the instructions further causes the processing circuitry to identify the time-sensitive operations, and wherein the portion of the Wi-Fi management or action frame is transmitted based on the identification of the time-sensitive operations.

Example 17 may include the non-transitory computer-readable medium of example 16 and/or some other example herein, wherein execution of the instructions further causes the processing circuitry to set a beacon interval between transmission of a first beacon comprising the portion of the Wi-Fi management or action frame and transmission of a second beacon based on the identification of the time-sensitive operations, wherein the portion of the Wi-Fi management or action frame is a portion of the first beacon, and wherein the portion of the Wi-Fi management or action frame is transmitted in the first beacon based on the beacon interval.

Example 18 may include the non-transitory computer-readable medium of example 16 and/or some other example herein, wherein execution of the instructions further causes the processing circuitry to determine that a first time to transmit the portion of the Wi-Fi management or action frame overlaps the transmission of the second time-sensitive frame, and wherein the portion of the Wi-Fi management or action frame is transmitted at a second time after the first time based on the overlap.

Example 19 may include a method for performing time-sensitive operations, the method comprising: generating, by processing circuitry of a Wi-Fi device, a first time-sensitive frame; transmiting, by the processing circuitry, the first time-sensitive frame to a station device during a transmission opportunity (TXOP) for time-sensitive operations for a station device generating, by the processing circuitry, a portion of a Wi-Fi management or action frame; transmitting, by the processing circuitry, the portion of the Wi-Fi management or action frame to the station device during the transmission opportunity after transmitting the first time-sensitive frame; generating, by the processing circuitry, a second time-sensitive frame; and transmitting, by the processing circuitry, the second time-sensitive frame during the transmission opportunity, wherein the first time-sensitive frame and the second time-sensitive frame are sent based on a periodicity associated with the time-sensitive operations.

Example 20 may include the method of example 19 and/or some other example herein, wherein the portion of the Wi-Fi management or action frame is a reduced size Wi-Fi management or action frame having a duration less than the a beacon defined by 802.1 1ax.

Example 21 may include an apparatus comprising means for: generating, by a Wi-Fi device, a first time-sensitive frame; transmiting the first time-sensitive frame to a station device during a transmission opportunity (TXOP) for time-sensitive operations for a station device generating a portion of a Wi-Fi management or action frame; transmitting the portion of the Wi-Fi management or action frame to the station device during the transmission opportunity after transmitting the first time-sensitive frame; generating a second time-sensitive frame; and transmitting the second time-sensitive frame during the transmission opportunity, wherein the first time-sensitive frame and the second time-sensitive frame are sent based on a periodicity associated with the time-sensitive operations.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of a wireless device, the apparatus comprising processing circuitry coupled to storage, the processing circuitry configured to:
generate a first time-sensitive frame;
transmit the first time-sensitive frame to a station device during a transmission opportunity (TXOP) for time-sensitive operations for the station device
generate a portion of a Wi-Fi management or action frame;
transmit the portion of the Wi-Fi management or action frame to the station device during the TXOP after transmitting the first time-sensitive frame;
generate a second time-sensitive frame; and
transmit the second time-sensitive frame during the TXOP, wherein the first time-sensitive frame and the second time-sensitive frame are sent based on a periodicity associated with the time-sensitive operations.

2. The apparatus of claim 1, wherein the portion of the Wi-Fi management or action frame is a reduced size Wi-Fi management or action frame.

3. The apparatus of claim 2, wherein a duration of the reduced size Wi-Fi management or action frame has a duration less than the a beacon defined by 802.11ax.

4. The apparatus of claim 1, wherein to transmit the portion of the Wi-Fi management or action frame to the station device comprises to transmit medium access control (MAC) layer protocol data units (MPDUs), the MPDUs comprising the portion of the Wi-Fi management or action frame.

5. The apparatus of claim 1, wherein the processing circuitry is further configured to identify the time-sensitive operations, and wherein the portion of the Wi-Fi management or action frame is transmitted based on the identification of the time-sensitive operations.

6. The apparatus of claim 5, wherein the processing circuitry is further configured to set a beacon interval between transmission of a first beacon comprising the portion of the Wi-Fi management or action frame and transmission of a second beacon based on the identification of the time-sensitive operations, wherein the portion of the Wi-Fi management or action frame is a portion of the first beacon, and wherein the portion of the Wi-Fi management or action frame is transmitted in the first beacon based on the beacon interval.

7. The apparatus of claim 5, wherein the processing circuitry is further configured to determine that a first time to transmit the portion of the Wi-Fi management or action frame overlaps the transmission of the second time-sensitive frame, and wherein the portion of the Wi-Fi management or action frame is transmitted at a second time after the first time based on the overlap.

8. The apparatus of claim 1, wherein the portion of the Wi-Fi management or action frame is part of a probe response, wherein the processing circuitry is further configured to determine that the station device is associated to a network of the AP device, and wherein the portion of the Wi-Fi management or action frame is transmitted based on the determination that the station device is associated to the network of the AP device.

9. The apparatus of claim 1, wherein the processing circuitry is further configured to:
determine, during transmission of the portion of the Wi-Fi management or action frame, a time until the transmission of the second time-sensitive frame; and
setting, based on the time until the transmission of the second time-sensitive frame, a guard band between transmission of the portion of the Wi-Fi management or action frame,
wherein the second time-sensitive frame and the portion of the Wi-Fi management or action frame are transmitted based on the guard band.

10. The apparatus of claim 1, further comprising a transceiver configured to transmit and receive wireless signals comprising the portion of the Wi-Fi management or action frame, the first time-sensitive frame, and the second time-sensitive frame.

11. The apparatus of claim 10, further comprising an antenna coupled to the transceiver to cause to send the wireless signals.

12. A computer-readable storage medium comprising instructions to cause processing circuitry of a wireless device, upon execution of the instructions by the processing circuitry, to:
generate a first time-sensitive frame;
transmit the first time-sensitive frame to a station device during a transmission opportunity (TXOP) for time-sensitive operations for the station device;
generate a portion of a Wi-Fi management or action frame;
transmit the portion of the Wi-Fi management or action frame to the station device during the TXOP after transmitting the first time-sensitive frame;
generate a second time-sensitive frame; and
transmit the second time-sensitive frame during the TXOP, wherein the first time-sensitive frame and the second time-sensitive frame are sent based on a periodicity associated with the time-sensitive operations.

13. The computer-readable storage medium of claim 12, wherein the portion of the Wi-Fi management or action frame is a reduced size Wi-Fi management or action frame.

14. The computer-readable storage medium of claim 13, wherein a duration of the reduced size Wi-Fi management or action frame has a duration less than the a beacon defined by 802.11ax.

15. The computer-readable storage medium of claim 12, wherein to transmit the portion of the Wi-Fi management or action frame to the station device comprises to transmit medium access control (MAC) layer protocol data units (MPDUs), the MPDUs comprising the portion of the Wi-Fi management or action frame.

16. The computer-readable storage medium of claim 12, wherein execution of the instructions further causes the processing circuitry to identify the time-sensitive operations, and wherein the portion of the Wi-Fi management or action frame is transmitted based on the identification of the time-sensitive operations.

17. The computer-readable storage medium of claim 16, wherein execution of the instructions further causes the processing circuitry to set a beacon interval between transmission of a first beacon comprising the portion of the Wi-Fi management or action frame and transmission of a second beacon based on the identification of the time-sensitive operations, wherein the portion of the Wi-Fi management or action frame is a portion of the first beacon, and wherein the portion of the Wi-Fi management or action frame is transmitted in the first beacon based on the beacon interval.

18. The computer-readable storage medium of claim 16, wherein execution of the instructions further causes the processing circuitry to determine that a first time to transmit the portion of the Wi-Fi management or action frame overlaps the transmission of the second time-sensitive frame, and wherein the portion of the Wi-Fi management or action frame is transmitted at a second time after the first time based on the overlap.

19. A method for performing time-sensitive operations, the method comprising:
generating, by processing circuitry of a wireless device, a first time-sensitive frame;
transmiting, by the processing circuitry, the first time-sensitive frame to a station device during a transmission opportunity (TXOP) for time-sensitive operations for the station device;
generating, by the processing circuitry, a portion of a Wi-Fi management or action frame;
transmitting, by the processing circuitry, the portion of the Wi-Fi management or action frame to the station device during the TXOP after transmitting the first time-sensitive frame;
generating, by the processing circuitry, a second time-sensitive frame; and
transmitting, by the processing circuitry, the second time-sensitive frame during the TXOP, wherein the first time-sensitive frame and the second time-sensitive frame are sent based on a periodicity associated with the time-sensitive operations.

20. The method of claim 19, wherein the portion of the Wi-Fi management or action frame is a reduced size Wi-Fi management or action frame having a duration less than the a beacon defined by 802.11ax.
